(19) United States
(12) Patent Application Publication
(10) Pub. No.: US 2004/0174850 A1
(43) Pub. Date: Sep. 9, 2004

(54) Method and device for providing a predetermined transmission rate for an auxiliary information

(76) Inventors: Anna-Mari Vimpari, Oulu (FI); Esa Malkamaki, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/774,532

(22) Filed: Feb. 10, 2004

Related U.S. Application Data
(60) Provisional application No. 60/447,735, filed on Feb. 19, 2003.

(51) Int. Cl. H04B 7/216

(52) U.S. Cl. 370/335; 370/342

(57) ABSTRACT

The present invention relates to a method for providing a predetermined transmission rate for an auxiliary information in a predetermined position at a data transmission stream. A combination of selectable transport formats, which determines an additional maximum allowable data rate higher by a predetermined rate amount than the maximum data rate of a signal transmitted via said predetermined channel, is set into a predetermined set of selectable combinations of selectable transport formats for the data transmission stream. This predetermined rate amount is then used to transmit said auxiliary information. Thereby, it can be ensured that a certain amount of auxiliary information is always provided at all specified information data rates of the data transmission stream.

The present application claims the benefit of priority of Provisional Application Serial No. 60/447,735, filed Feb. 19, 2003, the contents of whcih are incorporated herein by reference.

### FIELD OF THE INVENTION

The present invention relates to a method and device for providing a predetermined transmission rate for an auxiliary information in a channel of a transmission stream of a communication network, e.g., a third generation cellular network.

### BACKGROUND OF THE INVENTION

Within the International Telecommunications Union (ITU), several different air interfaces are defined for third generation mobile communication systems, based on either Code Division Multiple Access (CDMA) or Time Division Multiple Access (TDMA) technology. Wideband CDMA (WCDMA) is the main third generation air interface and will be deployed in Europe and Asia, including Japan and Korea, in the same frequency band, around 2 GHz.

WCDMA technology has shaped the WCDMA radio access network architecture due to the requirements of CDMA basic features, such as soft handover which is a category of handover procedures where the radio links are added and abandoned in such a manner that the terminal device, or user equipment (UE) in third generation terms, keeps at least one radio link to the radio access network.

The WCDMA air interface is based on CDMA technology. All users share the same carrier, and also share this carrier's power. The characteristic feature is the wide 5 MHz carrier bandwidth over which the signal for each user is spread. The transmission bandwidth is the same for all data rates, with the processing gain being larger for smaller data rates than for higher data rates. This processing gain protects against interference from other users active on the same carrier. In the receiver, de-spreading separates the transmitted and spread signal for data detection.

The WCDMA air interface has been defined to provide, in the first phase, data rates up to 2 Mbps in the 3GPP (third generation partnership project) Release 99 and Release 4 specifications. In the Release 5 specification, peak data rates up to 10 Mbps are possible with a high speed downlink packet access (HSDPA) feature to thereby support packet-based multimedia services. In HSDPA, the intelligence of the Node B, which is the third generation equivalent to the former base station, is increased for handling of retransmissions and scheduling functions, thus reducing the roundtrip delay between a mobile device and the network entity handling retransmissions, e.g., the radio network controller (RNC). This makes retransmission combining feasible in the mobile device due to reduced memory requirements. In general, all HSDPA users share the channel in both time and code domains. Adaptive modulation and coding is used to support multiple rate transmissions for different types of multimedia services.

In order to standardize the complementary uplink structure, i.e., Enhanced Uplink Packet Access (EUPA), to the HSDPA feature, it is expected to require the transmission of control information from the Node B, i.e., base station device, directly to the UE, i.e., terminal device, without involving the RNC or using a RRC (Radio Resource Control) signaling. Standardizations for enhancements of uplink dedicated channels (DCH), which are channels dedicated to a specific terminal device, e.g., mobile station or UE, are defined for example in the 3GPP Release 6 technical report TR 25.896.

On the dedicated physical data channel, the data rate can be varied. A transport format combination set (TFCS) defines the allowed transport format combinations for data streams, e.g., the Coded Composite Transport Channel (CCTrCH), resulting from encoding and multiplexing of one or several transport channels, and thus, also defines the CCTrCH data rates. The TFCS is assigned by protocol layer L3, i.e., the network layer, and given for the Medium Access Control (MAC) which is a sub-layer of the radio interface layer L2 and which provides an acknowledged data transfer service on logical channels and access to transport channels. MAC chooses between the TFCs given in the TFCS for each Transmission Time Interval (TTI) which can be defined as the inter-arrival time of transport block sets, i.e., the time it shall take to transmit a set of transport data blocks. Also a subset of a TFCS may be signalled to be used for a pre-defined duration.

Furthermore, the Transport Format Combination (TFC) defines, which transport formats (TFs) from the transport format sets (TFSs) of different transport channels can be simultaneously submitted to the physical layer L1 for transmission on the CCTrCH. Thus, the TFC is defined as the combination of currently valid TFs of a UE. A TF can be defined as a format offered by the physical layer L1 to MAC for the delivery of a transport block set during a TTI on a transport channel. For each transport channel, TFs are signaled with dynamic part, which includes transport block size and transport block set size, and a semi-static part, which includes transmission time interval, type of error protection, coding rate, static rate matching parameter and size of a cyclic redundancy code (CRC). TFS defines a list of all transport formats associated to a transport channel. The semi-static part is common for all transport formats within a TFS, only the dynamic parts are different. Variable bit rate may be achieved between each TTI, by changing either transport block set size only or both the transport block set size and the transport block size.

At the physical layer L1, discontinuous transmission (DTX) indication bits are inserted to fill up the dedicated physical channel (DPCH), if the data rate is below a predetermined maximum. Also, the DTX indication bits can be considered as dummy bits which can be replaced by control data or control bits to thereby enable the above mentioned desired direct transmission between the Node B and the UE. This solution currently looks very promising.

However, the method to insert DTX indication bits is different for fixed and flexible transport channel positions. With fixed transport channel positions, the room for the transport channel on the DPCH radio frame is reserved according to the maximum data rate of the transport channel. The possible DTX indication bits are inserted before transport channel multiplexing, separately for each transport channel. The last bits of the transport channel are DTX indication bits, if the transport channel data rate is below the maximum. With flexible transport channel positions, the place for data from different transport channels depends on the instantaneous transport formats and the rate matching at the physical layer L1 minimizes the number of DTX indication bits for the maximum CCTrCH data rate. Hence, it cannot be ensured that enough DTX indication bits are always provided as means for transporting control information. The possible DTX indication bits are inserted after the transport channel multiplexing to the end of the radio frame (of the last DPCH).

### SUMMARY OF THE INVENTION

It is an object of the present invention to provide a network feature or functionality, by means of which it can be ensured that a certain amount of DTX indication bits is provided in the data stream at all specified data rates.

This object is achieved by a method for providing a predetermined transmission rate for an auxiliary information in a predetermined channel of a data transmission stream, said method comprising the steps of:

setting for said data transmission stream an additional combination of selectable transport formats, which determines a maximum allowable data rate higher by a predetermined rate amount than the maximum data rate of a signal transmitted via said predetermined channel, into a predetermined set of selectable combinations of selectable transport formats; and

using said predetermined rate amount of said predetermined channel to transmit said auxiliary information.

Furthermore, the above object is achieved by a device for providing a predetermined transmission rate for an auxiliary information in a predetermined channel of a data transmission stream, said device comprising:

setting means for setting for said data transmission stream an additional combination of selectable transport formats, which determines a maximum allowable data rate higher by a predetermined rate amount than the maximum data rate of a signal transmitted via said channel, into a predetermined set of selectable combinations of selectable transport formats; and

transmission means for transmitting said auxiliary information in said channel by using said predetermined rate amount.

Accordingly, due to the fact that the determined maximum allowable data rate exceeds the actual maximum data rate, it can be assured that with all specified information data rates there is always a certain amount of auxiliary information, e.g., DTX indication bits or the like, in the data transmission stream at same positions.

The transmission stream may be a multiplex signal having at least one channel, and said selectable transport formats can be allocated to said at least one channel.

The setting step may comprise adding to a set of transport format combinations selectable for the at least one channel a new transport format combination which determines for the predetermined channel a new transport format leading to the maximum allowable data rate. By including into the set of transport format combinations a combination which defines an higher maximum data rate than actually used, it can be ensured that there is always a certain amount of auxiliary information bits at the end of each transmission frame, regardless of the transport channel position method and instantaneous data rates. The new transport format combination may include a transport format with transport block(s) of appropriate size(s) resulting in the higher maximum allowable data rate for the predetermined channel.

Furthermore, the added new transport format combination may comprise a frame format selected for the predetermined channel from a set of existing frame formats allocated to the predetermined channel, wherein the selected frame format defines for the predetermined channel a predetermined transport block size leading to the maximum allowable data rate. By adding to the set of transport format combinations a new combination which includes an existing transport format from the transport format set of the predetermined channel, it can be ensured that the transport format which defines the desired maximum allowable data rate for the predetermined channel is included in the transport format combination which defines the maximum data rate for the whole data transmission stream, e.g. the CCTrCH.

As an alternative, the setting step may comprise adding to the data transmission stream a new channel, and allocating to the new channel a set of selectable transport formats comprising a transport format which determines the maximum allowable data rate. If only the other transport formats of the allocated set of selectable transport formats are then used, the excessive predetermined rate amount can be used for transmitting the auxiliary information.

As a further alternative, the setting step may comprise setting a restriction for using only a subset of selectable transport format combinations for the data transmission stream. Then, the maximum number of bits that will be delivered to the physical layer is known and enough capacity can be provided for the auxiliary information.

The predetermined channel may be located at a predetermined fixed position within said at least one channel. As an example, the fixed position may correspond to the last channel position within a frame of the data transmission stream.

Furthermore, the maximum allowable data rate may define transport blocks of a predetermined size in the data transmission stream.

The auxiliary information may comprise a DTX information. It may be replaced by a control information to thereby provide signaling capacity in enhanced systems, e.g., enhanced uplink systems of a cellular network. The control information may be a HSDPA signaling information. The channel may be a dedicated channel.

Further advantageous modifications are defined in the dependent claims.

### BRIEF DESCRIPTION OF THE DRAWINGS

In the following, the present invention will be described in greater detail based on preferred embodiments with reference to the accompanying drawings, in which:

FIG. 1 shows a schematic diagram of a network architecture in which the present invention can be implemented;

FIG. 2 shows possible DPDCH data structures for a radio frame with flexible transport channel positions;

FIG. 3 shows possible DPDCH data structures for a radio frame with fixed transport channel positions; and

FIG. 4 shows a schematic block diagram of a transport channel multiplexing structure for a downlink direction according to the preferred embodiments.

### DESCRIPTION OF THE PREFERRED EMBODIMENTS

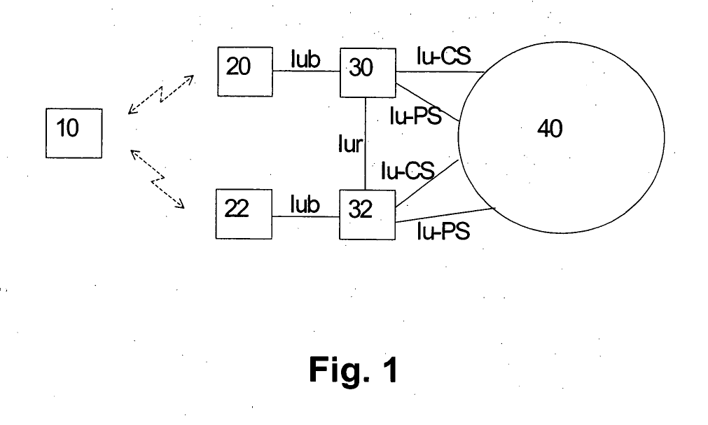

The preferred embodiments will now be described on the basis of a third generation WCDMA radio access network architecture as shown in FIG. 1.

FIG. 1 shows a terminal device or UE 10 connected via an air interface to a first Node B 20 and/or a second Node B 22. The first and second Node Bs 20, 22 are connected via respective lub interfaces to first and second radio network controllers (RNCs) 30, 32 which are connected to each other via a lur interface. The Node Bs 20, 22 are logical nodes responsible for radio transmission and reception in one or more cells to/from the UE 10 and terminate the lub interface towards the respective RNCs 30, 32. The RNCs 30, 32 are in charge of controlling use and integrity of radio resources within the radio access network. Furthermore, the RNCs 30, 32 provide connections to a third generation core network 40, e.g., a UMTS (Universal Mobile Telecommunications System) network for both circuit-switched traffic via a lu-CS interface and packet-switched traffic via a lu-PS interface. The existence of an open standardized lur interface is essential for proper network operation, including soft handover support in a multi-vendor environment.

Furthermore, a network functionality is provided by means of which a control information, e.g., a HSDPA or other signaling information, can be exchanged between the Node Bs 20, 22 and the UE 10 without involving the respective RNCs 30, 32. To achieve this, a dummy information or dummy bits are provided at predetermined positions of a dedicated uplink or downlink signal. These positions can then be used by the Node Bs 20, 22 or by the UE 10 to insert a desired control signaling, i.e., replace the dummy information or dummy bits by the desired control information or control bits. Thus, the dummy information or dummy bits can be regarded as fictive information or data, which does not carry any specific information.

In the WCDMA system, each frame consists of 15 slots S#0 to S#14, of which each slot comprises two Transport Format Combination Indicator (TFCI) bits which together with TFCI bits from other slots of the frame represent the current transport format combination, i.e., the combination of currently valid transport formats on all transport channels of the concerned UE. In particular, the transport format combination contains one transport format for each transport channel. Different types of transport channels are defined by how and with which characteristic data is transferred on the physical layer, e.g., further using dedicated or common physical channels. Further details concerning the WCDMA frame structure are described in the 3GPP specifications TS 25.211 and 25.212.

In downlink, if a transport channel has less than the maximum number of bits to transmit DTX indication bits or the like are provided as an auxiliary information in a predetermined position of a time slot of the time multiplex signal. The DTX indication bits are provided in different places within the frame structure of the time multiplex signal depending on whether fixed positions or flexible positions of the TrCHs are used. There are several possibilities how the fixed positions for the dummy bits can be arranged. The Node Bs 20, 22 using, e.g., advanced uplink scheduling improvements, as informed to the UE 10, are arranged to use the DTX indication bits provided in each slot, for a Node B specific control signaling, e.g., a HSDPA control signaling or the like. Other Node Bs not involved in the improved uplink scheduling operation do not transmit anything there, i.e., do not replace the DTX indication bits by signaling bits.

The DTX bits are replaced by the control bits at the selected slots after the final interleaving function, i.e., the second interleaving in the present WCDMA system, when the final positions are known. Non-replaced DTX indication bits are not transmitted.

In general the proposed control signaling can be used in both uplink and downlink directions. In the uplink direction the dummy bits may be filled by the rate matching functionality. The enhanced Node Bs would then decode the control bits, e.g., after decoding of the TFCI, while the conventional Node Bs would treat the control data as a normal transmission channel, decode it and pass it to the respective RNC 30, 32, which then interprets the received data as dummy data.

The provision of enough DTX indication bits can be ensured by adding a TFC defining for the CCTrCH and the last TrCH a new maximum data rate, which would never be used simultaneously with the enhanced dedicated channel uplink signaling (E-DCH uplink), into TFCS to ensure that there would be always at least certain amount of DTX indication bits in each radio frame. If the position of the ensured DTX indication bits is known, they can be replaced by L1 signaling bits after the 2^{nd} interleaving.

The method to insert DTX indication bits is different for fixed and flexible transport channel positions. With flexible transport channel positions, the place for data from different transport channels depends on the instantaneous transport formats and rate matching minimizes the number of DTX indication bits for the maximum CCTrCH data rate. The possible DTX indication bits are inserted after the transport channel multiplexing to the end of the radio frame on the CCTrCH. With fixed transport channel positions, the room for the transport channel is reserved according to the maximum transport format of the transport channel. The last bits of the transport channel are DTX indication bits, if the transport channel data rate is below the maximum. The DTX indication bits of the last transport channel (DCH) are at the end of the radio frame of the CCTrCH. If multicode transmission is used, i.e., the bits of the CCTrCH are transmitted using several physical channels DPDCHs, then the DTX indication bits are on the last DPDCH when flexible TrCH positions are used. With fixed TrCH positions, the DTX bits of the last DCH are also always on the last DPDCH.

It is now assumed, that, e.g., thirty DTX indication bits are needed. Then the thirty last bits of the radio frame on the CCTrCH before 2^{nd} interleaving will be the last bits of the first and second half of the DPDCH data in each slot of the radio frame after the 2^{nd} interleaving. Thus, with thirty DTX indication bits at the end of each radio frame before the 2^{nd} nd interleaving, two bits in each slot, i.e., the last bits of the first and second half of the Dedicated Physical Data Channel (DPDCH) data, are known to be DTX indication bits. With less than thirty DTX indication bits per radio frame, there would not be DTX indication bits in each slot, but the positions of these bits inside the radio frame are known from the 2^{nd} nd interleaving pattern. In case of multicode transmission, these DTX bits are on the last DPDCH.

A minimum amount of DTX indication per each radio frame can be ensured by higher protocol layers by including into TFCS a new TFC, which defines a new downlink maximum data rate, which is never used for the CCTrCH at the same time as the above mentioned specific downlink signaling is used. When the additional TFC defines a new maximum data rate for the last transport channel, the ensured DTX indication bits are located at the end of the radio frame of the last DPCH with both transport channel position methods. Thus, the ensured DTX indication bits are at known positions and can be replaced by the L1 signaling bits after 2^{nd} nd interleaving in desired slots. The L1 signaling bits are then available at the UE as fast as the DPCCH bits. The Node Bs that have no L1 signaling to send, including Node Bs, which do not support E-DCH in uplink, can behave with the DTX indication bits as defined in the respective 3GPP release '99 specifications, i.e., turn off the transmission.

According to the preferred embodiments, it can be ensured that with all specified information data rates there are always a certain amount of DTX indication bits on the CCTrCH at same fixed positions. At the 2^{nd} nd interleaving, the ensured DTX indication bits are spread over the radio frame, but the positions of these bits are fixed and known, regardless of the transport channel position method and the used TFC. The ensured DTX indication bits can be replaced by control signaling as described above.

By including into TFCS a TFC, which defines a higher than actually used, maximum data rate for the last transport channel and also for CCTrCH, it can be ensured that there are always, regardless of the transport channel position method and instantaneous data rates, a certain amount of DTX indication bits on the CCTrCH at the end of each radio frame, before the 2^{nd} nd interleaving.

According to a first preferred embodiment, this can be achieved by adding into TFCS a new TFC, which includes for the last transport channel a new transport format (TF) defining a higher than actually used maximum data rate for the transport channel and also for CCTrCH.

According to a second preferred embodiment, the assured amount of DTX indication bits can be achieved by adding into TFCS a new TFC, including an existing TF from the transport format set (TFS) of the last transport channel, added into the TFCS, resulting a higher than actually used maximum data rate for the transport channel and also for CCTrCH. This is advantageous due to the fact that the TF which defines the maximum data rate for the last transport channel, may not be included in the TFC which defines the maximum data rate for the CCTrCH.

According to a third preferred embodiment, the assured amount of DTX indication bits can be achieved by adding a new last transport channel with two TFs in the TFS. The first TF defines a transport block with appropriate size and the second transport block defines a smaller transport block size, e.g. a 0× transport block size. Then, only the second TF with the smaller transport block size is used. The first TF would be added into an additional TFC in TFCS.

According to a fourth preferred embodiment, the assured amount of DTX indication bits can be achieved by setting restrictions at higher layers so that only a subset of the allowed TFCs are used, when the enhanced uplink DCH is used. The maximum number of bits that will be delivered to the physical layer are then known and there are enough DTX indication bits. However, it must be ensured that the needed amount of DTX indication bits is provided and that the positions of the DTX indication bits are the same with both transport channel position methods. The downlink maximum data rate would be restricted with this method, but the performance would not be degraded.

Including a new TFC ensures that the spreading factor (SF) and the rate matching parameters are selected such that with other (than the new) TFCs there are always enough DTX indication bits available.

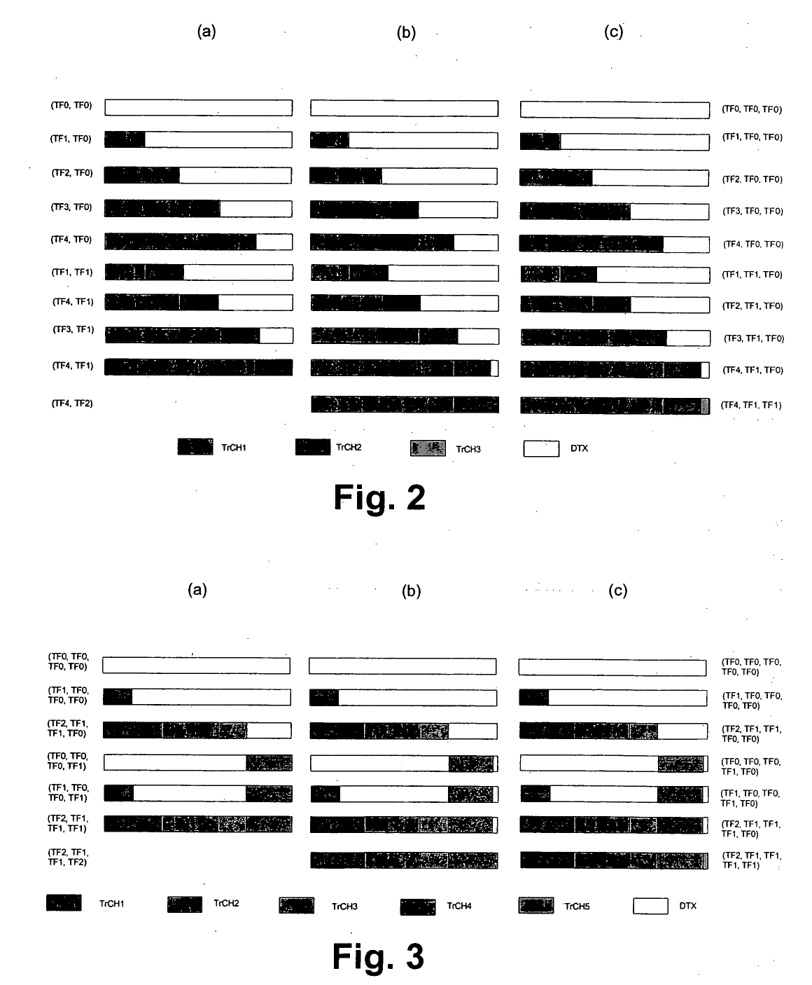

In the following, resulting DPDCH data structures for a radio frame before the 2^{nd} nd interleaving are described with reference to FIGS. 2 and 3.

FIG. 2 shows a schematic diagram indicating possible DPDCH data structures for flexible transport channel positions in a two-channel system. In particular, FIG. 2(a) shows data structures for a conventional system with TFCS without additions. Consequently, no DTX indication bits are provided at highest data rate of the TFC comprising the longest TF (TF4) in the first channel TrCH1 and a short TF (TF1) in the second channel TrCH2.

FIG. 2(b) shows possible DPDCH data structures according to the first preferred embodiment with ensured DTX for all used TFCs, provided that the lowest TFC, i.e. (TF4, TF2) is never used. Thus, the new TFC shown as the lowest data structure of FIG. 2(b) with additional longer TF (TF2) for the second channel TrCH2 only serves to ensure enough DTX.

FIG. 2(c) shows possible DPDCH data structures according to the third preferred embodiment with ensured DTX for all used TFCs by adding an additional third or last channel TrCH3 and a new TFC shown as the lowest data structure of FIG. 2(c). Here, the new TFC defines the use of the new last channel TrCH3 and only serves to ensure enough DTX.

FIG. 3 shows a schematic diagram indicating possible DPDCH data structures for fixed transport channel positions in a four-channel system. In particular, FIG. 3(a) shows data structures for a conventional system with TFCS without additions. Consequently, no DTX indication bits are provided at highest data rate of the TFC comprising the longest TFs, i.e. (TF2, TF1, TF1, TF1).

FIG. 3(b) shows possible DPDCH data structures according to the first preferred embodiment with ensured DTX for all used TFCs, provided that the lowest TFC, i.e., (TF2, TF1, TF1, TF2) is never used. Thus, the new TFC shown as the lowest data structure of FIG. 3(b) with additional longer TF (TF2) for the last or fourth channel TrCH4 only serves to ensure enough DTX.

FIG. 3(c) shows possible DPDCH data structures according to the third preferred embodiment with ensured DTX for all used TFCs by adding an additional fifth or last channel TrCH5 and a new TFC shown as the lowest data structure of FIG. 3(c). Here, the new TFC defines the use of the new last channel TrCH5 and only serves to ensure enough DTX.

As an example, in the following, modifications needed to ensure, e.g., thirty DTX indication bits in each radio frame of a data structure of fixed channel positions as shown in FIG. 3 are indicated based on practical examples. It should however be noted that with similar actions any number of DTX indication bits can be achieved. The number of thirty is just used as an example here.

By adding a new TF for the existing last transport channel TrCH4, the following exemplary settings can be made based on the first preferred embodiment:

TrCH1: Transport block sizes 0 bits, 39 bits and 81 bits, TFS: TF0 1×0, TF1 1×39, TF2 1×81, 20 ms TTI, RM 220, CC ⅓, CRC:12 bits;

TrCH2: Transport block sizes 103 bits, TFS: TF0 0×103, TF1 1×103, 20 ms TTI, CC ⅓, RM 210, CRC:N/A;

TrCH3: Transport block sizes 60 bits, TFS: TF0 0×103, TF1 1×103, 20 ms TTI, CC ½, RM 256, CRC:N/A;

TrCH4: Transport block sizes 148 bits and 159 bits, TFS: TF0 0×148, TF1 1×148, TF2 1×159, 40 ms TTI, CC ⅓, RM 185, CRC:16 bits;

TFCS: (TF0, TF0, TF0, TF0), (TF1, TF0, TF0, TF0), (TF2, TF1, TF1, TF0), (TF0, TF0, TF0, TF1), (TF1, TF0, TF0, TF1), (TF2, TF1, TF1, TF1), (TF2, TF1, TF1, TF2).

The setting of 159 bits for the transport block size to be used in TF2 according to the last TFCS only serves to ensure the desired thirty DTX indication bits in each radio frame.

By adding a new last transport channel, the following exemplary settings can be made based on the third preferred embodiment:

TrCH1: Transport block sizes 0 bits, 39 bits and 81 bits, TFS: TF0 1×0, TF1 1×39, TF2 1×81, 20 ms TTI, CC ⅓, RM 220, CRC:12 bits;

TrCH2: Transport block sizes 103 bits, TFS: TF0 0×103, TF1 1×103, 20 ms TTI, CC ⅓, RM 210, CRC:N/A;

TrCH3: Transport block sizes 60 bits, TFS: TF0 0×103, TF1 1×103, 20 ms TTI, CC ½, RM 256, CRC:N/A;

TrCH4: Transport block sizes 148 bits, TFS: TF0 0×148, TF1 1×148, 40 ms TTI, CC ⅓, RM 185, CRC:16 bits;

TrCH5: Transport block sizes 30 bits, TFS: TF0 0×30, TF1 1×30, 20 ms TTI, CC ⅓, RM 190, CRC:N/A;

TFCS: (TF0, TF0, TF0, TF0, TF0), (TF1, TF0, TF0, TF0, TF0), (TF2, TF1, TF1, TF0, TF0), (TF0, TF0, TF0, TF1, TF0), (TF1, TF0, TF0, TF1, TF0), (TF2, TF1, TF1, TF1, TF0), (TF2, TF1, TF1, TF1, TF1).

Here, the settings of the new fifth channel TrCH5, the addition of the fifth TF in each TFCS and the last TFCS only serve to ensure the desired thirty DTX indication bits in each radio frame.

As an example, in the following, modifications needed to ensure thirty DTX indication bits in each radio frame of a data structure of flexible channel positions as shown in FIG. 2 are indicated based on practical examples.

By adding a new TF for the existing last transport channel TrCH2, the following exemplary settings can be made based on the first preferred embodiment:

TrCH1: Transport block sizes 336 bits, TFS: TF0 0×336, TF1 1×336, TF2 2×336, TF3 3×336, TF4 4×336, 20 ms TTI, TC ⅓, RM 170, CRC:16 bits;

TrCH2: Transport block sizes 148 bits and 167 bits, TFS: TF0 0×148, TF1 1×148, TF2 1×167, 40 ms TTI, CC ⅓, RM 256, CRC:16 bits;

TFCS: (TF0, TF0), (TF1, TF0), (TF2, TF0), (TF3, TF0), (TF4, TF0), (TF0, TF1), (TF1, TF1), (TF2, TF1), (TF3, TF1), (TF4, TF1), (TF4, TF2).

Here, the setting of 167 bits for the transport block size to be used in TF2 according to the last TFCS only serves to ensure the desired thirty DTX indication bits in each radio frame.

By adding a new last transport channel, the following exemplary settings can be made based on the third preferred embodiment:

TrCH1: Transport block sizes 336 bits, TFS: TF0 0×336, TF1 1×336, TF2 2×336, TF3 3×336, TF4 4×336, 20 ms TTI, TC ⅓, RM 170, CRC:16 bits;

TrCH2: Transport block sizes 148 bits, TFS: TF0 0×148, TF1 1×148, 40 ms TTI, CC ⅓, RM 256, CRC:16 bits;

TrCH3: Transport block sizes 8 bits, TFS: TF0 0×8, TF1 1×8, 20 ms TTI, CC ½, CRC:N/A;

TFCS: (TF0, TF0, TF0), (TF1, TF0, TF0), (TF2, TF0, TF0), (TF3, TF0, TF0), (TF4, TF0, TF0), (TF0, TF1, TF0), (TF1, TF1, TF0), (TF2, TF1, TF0), (TF3, TF1, TF0), (TF4, TF1, TF0), (TF4, TF1, TF1).

Here, the settings of the new third channel TrCH3, the addition of the third TF in each TFCS and the last TFCS only serve to ensure the desired thirty DTX indication bits in each radio frame.

An advantage of using the existing signaling is that old Node Bs understand it and would not transmit anything on those positions, i.e. old Node Bs would not be able to replace the DTX indication bits with control bits. Thus, compatibility with conventional systems can be assured.

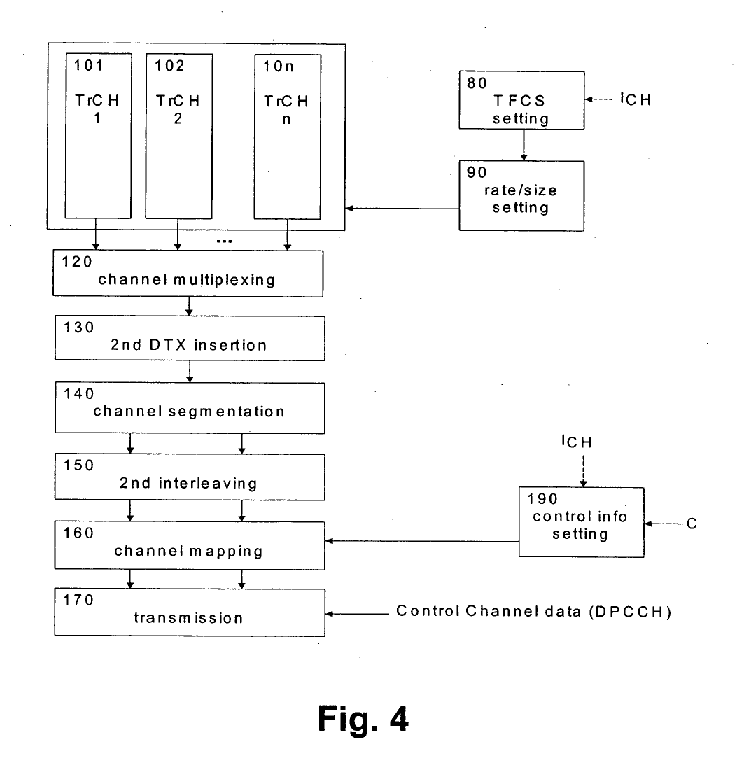

FIG. 4 shows a schematic diagram of a WCDMA transport channel multiplexing structure for the downlink direction, as provided in a transmitting entity, e.g., the Node Bs 20, 22. According to this multiplexing structure, channel signals obtained from individual channel processing stages 101, 102 to 10n of the channels TrCH1, TrCH2, . . . , TrCHn are multiplexed at a transport channel multiplexing function 120. The multiplex signal is then processed in a second insertion function 130 of a DTX indication and supplied to a physical channel segmentation function 140. The segmented physical channel signals are supplied to a second interleaving function 150 and a physical channel mapping function 160 before being processed for transmission in a transmission unit 170 together with control channel data supplied e.g., from a dedicated physical control channel (DPCCH). A control information setting unit 190 is provided to which the desired control bits C replacing the DTX bits are supplied.

A TFCS setting unit 80 is provided for setting the TFCS to be used for the connection. The TFCS setting unit 80 may be part of or controlled by a L3 processing unit and is arranged to control a rate/size setting unit 90 which may be part of or controlled by a MAC processing unit so as to select between the TFCs given in the TFCS for each TTI. Based on the selected TFCs, the individual channel processing stages 101, 102 to 10n of the channels TrCH1, TrCH2, . . . , TrCHn are controlled to generate corresponding channel signals with appropriate data rates and/or block sizes.

If the control signaling for the E-DCH uplink functionality is to be transmitted, a corresponding channel information I_{CH} is supplied to the TFCS setting unit 80 in order to ensure the desired amount of DTX data is included in the combined transmission signal.

Based on the channel information I_{CH}, the control information setting unit 190 replaces the DTX data by the supplied control data C. This may be achieved, e.g., in the physical channel mapping function 160 after the second interleaving function 150.

The control unit which generates the control data C may be, e.g., the MAC or physical layer of the Node B or the UE, the controlled unit can be, e.g., UE or the Node B, respectively. The controlled unit could typically be the MAC or physical layer of the UE or Node B. The control unit receives some data and some DTX information or bits. In case the Node B is the control unit, it typically receives the data from RNC, but especially when the control unit is the MAC or physical layer of the Node B, the data can also come from the higher protocol layers of the Node B. In case, the UE, and especially the MAC or physical layer of the UE, is the control unit, the data is typically received from the higher protocol layers of the UE. The control unit replaces at least part of the DTX information with the control information that it wants to send to the controlled unit and transmits the data and the control information to the controlled unit.

It is noted that the present invention is not restricted to the above preferred embodiments but can be used in any transmission signal so as to assure provision of a desired amount of auxiliary information, e.g., DTX information, at an intermediate network node provided on a transmission path to a controlled receiving entity. The preferred embodiments may thus vary within the scope of the attached claims.

What is claimed is:

1. A method for providing a predetermined transmission rate for an auxiliary information in a predetermined channel of a data transmission stream, said method comprising the steps of:
setting for said data transmission stream an additional combination of selectable transport formats, which determines a maximum allowable data rate higher by a predetermined rate amount than the maximum data rate of a signal transmitted via said predetermined channel, into a predetermined set of selectable combinations of selectable transport formats; and
using said predetermined rate amount of said predetermined channel to transmit said auxiliary information.

2. A method according to claim 1, wherein said transmission stream is a multiplex signal having at least one channel, and said selectable transport formats can be allocated to said at least one channel.

3. A method according to claim 2, wherein said setting step comprises adding to a set of transport format combinations selectable for said at least one channel a new transport format combination which determines for said predetermined channel a new transport format leading to said maximum allowable data rate.

4. A method according to claim 3, wherein said new transport format combination comprises a transport format selected for said predetermined channel from a set of existing transport formats allocated to said predetermined channel, said selected transport format leading to an additional maximum allowable data rate for said transmission stream.

5. A method according to claim 2, wherein said setting step comprises adding to said data transmission stream a new channel, and allocating to said new channel a set of selectable transport formats comprising a transport format which determines said maximum allowable data rate.

6. A method according to claim 2, wherein said setting step comprises setting a restriction for using only a subset of selectable transport format combinations for said data transmission stream.

7. A method according to claim 1, wherein said predetermined channel is located at a predetermined fixed position within said at least one channel.

8. A method according to claim 7, wherein said fixed position corresponds to the last channel position within a frame of said data transmission stream.

9. A method according to claim 1, wherein said maximum allowable data rate defines transport blocks of a predetermined size in said data transmission stream.

10. A method according to claim 1, wherein said auxiliary information comprises a discontinuous transmission information.

11. A method according to claim 1, wherein said channel is a dedicated channel.

12. A method according to claim 1, wherein said data transmission stream is a downlink signal of a cellular network.

13. A method according to claim 1, wherein said auxiliary information is replaced by a control information.

14. A method according to claim 13, wherein said control information comprises HSDPA signaling information.

15. A device for providing a predetermined transmission rate for an auxiliary information in a predetermined channel of a data transmission stream, said system comprising:
setting means for setting for said data transmission stream an additional combination of selectable transport formats, which determines a maximum allowable data rate higher by a predetermined rate amount than the maximum data rate of a signal transmitted via said channel, into a predetermined set of selectable combinations of selectable transport formats; and
transmission means for transmitting said auxiliary information in said channel by using said predetermined rate amount.

16. A device according to claim 15, wherein said setting means is arranged to add to a set of transport format combinations selectable for said at least one channel a new transport format combination which determines for said predetermined channel a new transport format leading to said maximum allowable data rate.

17. A device according to claim 16, wherein said new transport format combination comprises a frame format selected for said predetermined channel from a set of existing frame formats allocated to said predetermined channel, said selected frame format defining for said predetermined channel said maximum allowable data rate.

18. A device according to claim 15, wherein said setting means is arranged to add to said data transmission stream a new channel, and to allocate to said new channel a set of selectable transport formats comprising a transport format which determines said maximum allowable data rate.

19. A device according to claim 15, wherein said setting means is arranged to set a restriction for using only a subset of selectable transport format combinations for said signal transmitted via said predetermined channel.

20. A device according to claim 15, wherein said device is a base station device.
